(19) United States
(12) Patent Application Publication
(10) Pub. No.: US 2017/0214206 A1
(43) Pub. Date: Jul. 27, 2017

(54) APPARATUS AND METHOD FOR ASSEMBLING AN ELECTRICAL WHIP

(71) Applicant: WAL-MART STORES, INC., Bentonville, AR (US)

(72) Inventors: James W. Oehlert, Bentonville, AR (US); Rodrick K. Webster, Purdy, MO (US); Tony R. Sparks, Bentonville, AR (US)

(21) Appl. No.: 15/328,890

(22) PCT Filed: Jul. 28, 2015
(86) PCT No.: PCT/US15/42382

§ 371 Date: Jan. 24, 2017

Related U.S. Application Data
(60) Provisional application No. 62/029,749, filed on Jul. 28, 2014.

(51) Int. Cl. H01R 43/22; H02G 3/06; B25B 27/02

(52) U.S. Cl. CPC H01R 43/22; B25B 27/02; H02G 3/06

(57) ABSTRACT

Methods and apparatuses are provided to assemble an electrical whip. In some embodiments, a connection device comprises a fixed block having a cable engagement portion to engage an end portion of a metal clad cable having wiring extending therefrom; a retaining device releasably retaining the end portion of the cable against the cable engagement portion; a piston having a connector alignment portion and an end wall, the connector alignment portion receiving a connector with the electrical wiring extending therethrough, and the end wall contacting the connector while allowing the electrical wiring to extend therethrough; a handle; and a hinge assembly pivotally coupling the handle to the block and piston, wherein upon a manipulation of the handle, the piston including the connector alignment portion and the end wall slide linearly toward the block pressing the connector onto the end of the cable as it is retained in position.

### RELATED APPLICATION(S)

This application claims the benefit of U.S. Provisional Application No. 62/029,749, filed Jul. 28, 2014, which is incorporated by reference in its entirety herein.

### TECHNICAL FIELD

This invention relates generally to the assembly of an electrical whip that electrically connects an electrical device or appliance to a power supply.

### BACKGROUND

An electrical whip assembly is a generally a connector assembly to connect electrical power to an electrical appliance. It usually includes a flexible conduit, connector fittings on each end of the conduit for attaching the conduit to a panel or enclosure, and electrical conductors inside the conduit to carry power to the appliance. The connector fittings are usually attached to the flexible conduit via a threaded mechanical connection and allow the electrical whip to be connected to a knockout in a junction box. The fitting is typically mechanically threaded or pressed onto the conduit through manual human effort.

### BRIEF DESCRIPTION OF THE DRAWINGS

Disclosed herein are embodiments of apparatuses and methods pertaining to a connection device for use in assembling an electrical whip. This description includes drawings, wherein:

FIGS. 1 and 2 are simplified views of an electrical whip having the connector or fitting not attached and attached, respectively, to the conduit, in accordance with several embodiments.

FIGS. 3 and 4 are front side views of a connection device in an open orientation and a closed orientation, respectively, in accordance with several embodiments.

FIGS. 5 and 6 are back side views of the connection device of FIGS. 3 and 4 in the open orientation and the closed orientation, respectively, in accordance with several embodiments.

FIGS. 7 and 8 are top-down views of the connection device of FIGS. 3 and 4 in the open orientation and the closed orientation, respectively, in accordance with several embodiments.

FIGS. 9 and 10 are front side perspective views of the connection device of FIGS. 3 and 4 in the open orientation and the closed orientation, respectively, in accordance with several embodiments.

FIGS. 11 and 12 are back side perspective views of the connection device of FIGS. 3 and 4 in the open orientation and the closed orientation, respectively, in accordance with several embodiments.

FIGS. 13 and 14 are front side views of a portion of the connection device of FIGS. 3 and 4 with the electrical whip having the connector or fitting not attached and attached, respectively, to the conduit, in accordance with several embodiments.

FIG. 15 is a simplified view of a retaining device of the connection device of FIGS. 3 and 4 in accordance with some embodiments.

FIG. 16 is a flow diagram of a process of assembling an electrical whip using a connection device according to some embodiment.

FIGS. 17 and 18 are simplified views of an electrical whip with a jacketed cable or conduit and having the connector or fitting not attached and attached, respectively, to the conduit, in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods arc provided herein useful to assemble an electrical whip including the connection of a fitting or connector to a metal clad cable having electrical wiring extending therefrom. In some embodiments, a connection device for use in assembling an electrical whip comprising: a block portion fixed in position and having a cable engagement portion configured to engage an end portion of a metal clad cable having electrical wiring extending therefrom; a retaining device coupled to the block portion and configured to releasably retain the end portion of the metal clad cable against the cable engagement portion; a piston portion having a connector alignment portion and an end wall portion, wherein the connector alignment portion is configured to receive a connector with the electrical wiring extending therethrough, and wherein the end wall portion is configured to contact the connector while allowing the electrical wiring to extend therethrough; a handle; and a hinge assembly pivotally coupling the handle to the block portion and to the piston portion, wherein upon a manipulation of the handle, the piston portion including the connector alignment portion and the end wall portion slide linearly toward the block portion pressing the connector onto the end of the metal clad cable as it is retained against the cable engagement portion by the retaining device.

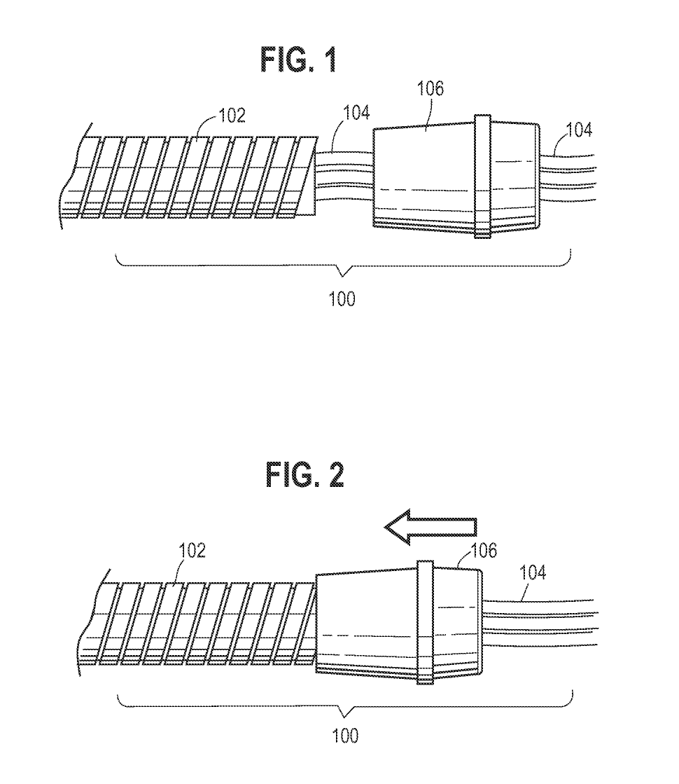

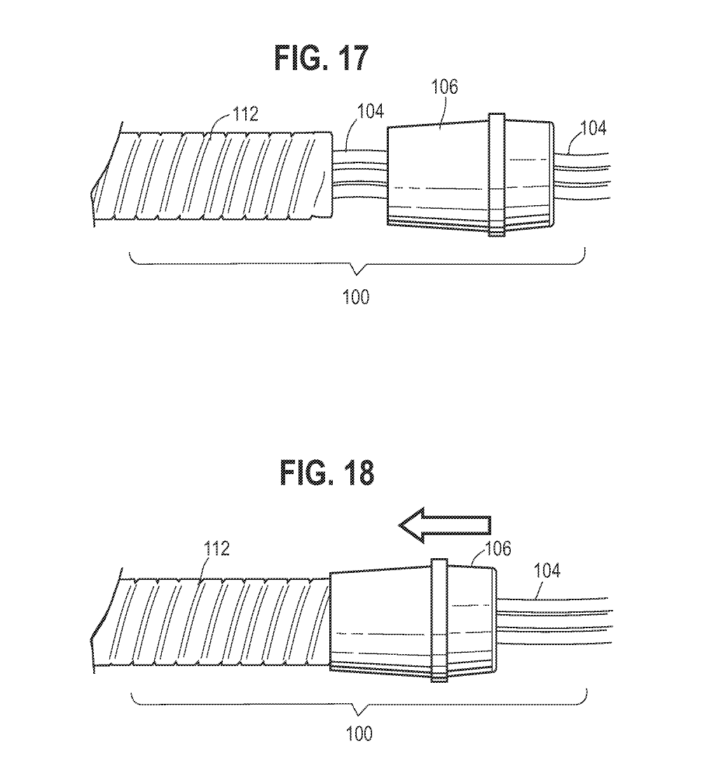

FIGS. 1 and 2 illustrate an electrical whip 100 including a non-jacketed flexible conduit or non-jacketed metal clad (MC) cable 102 having electrical wires 104 extending therefrom and a fitting or connector 106. Alternatively, FIGS. 17 and 18 illustrate an electrical whip 100 including a jacketed flexible conduit or jacketed metal clad (MC) cable 112 having the electrical wires 104 extending therefrom and the fitting or connector 106. A jacketed cable is a flexible metal cable having a coating or sheath surrounding the cable to increase the watertight feature of the cable. Jacketed cables are slightly thicker in diameter than non-jacketed cables. In FIGS. 1 and 17, the wires 104 are inserted through an opening in the connector 106, but the connector is not attached to the end of the cable 102/cable 112. In FIGS. 2 and 18, the connector 106 is attached to the end of the cable 102/cable 112. The assembled electrical whip 100 of FIGS. 2 and 18 is ready for connection or mating to a junction box, panel, enclosure, or other electrical appliance. Depending on the type, the connector 106 is manually threaded onto or manually pressed over the conduit 102. This connection process is performed by hand and is difficult to perform quickly. Thus user needs to physically force the cable into the connector which is difficult, in particular with the jacketed cable 112.

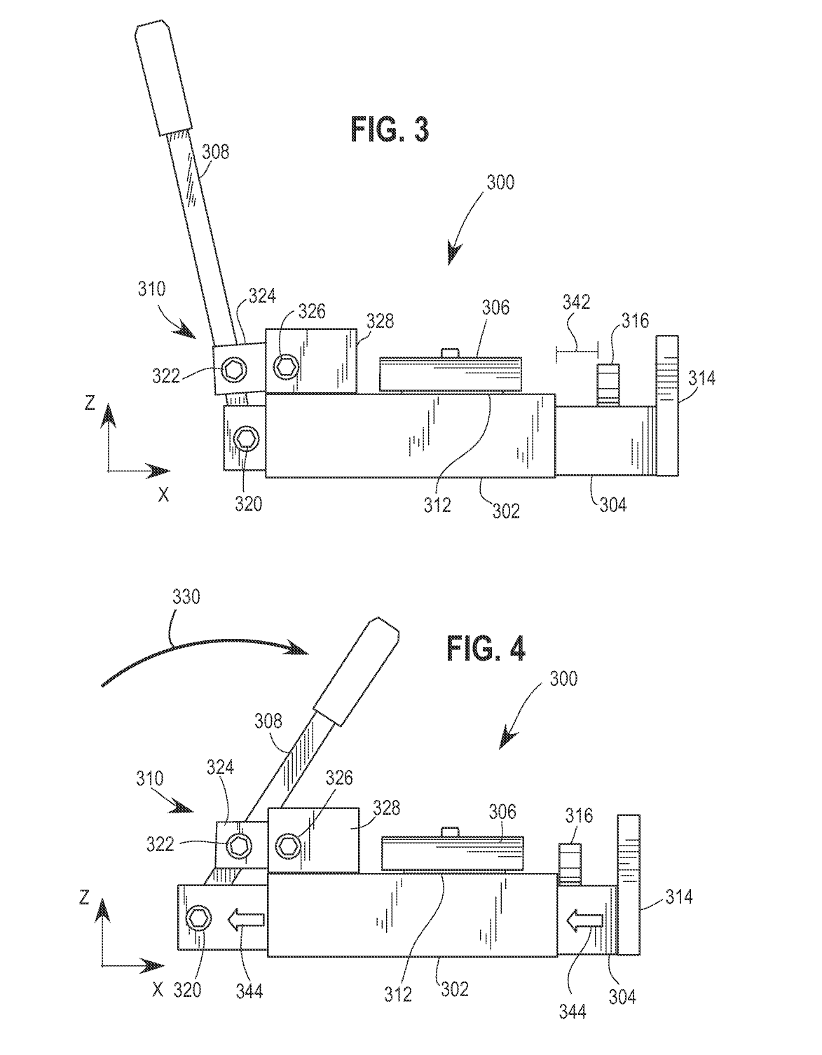

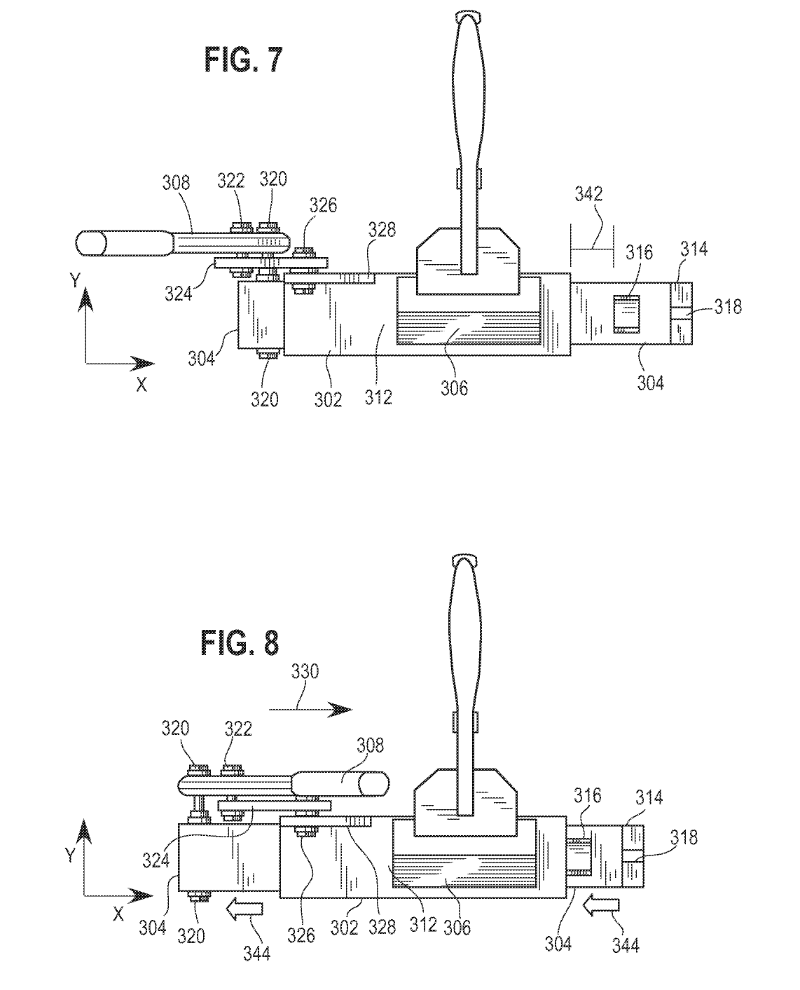

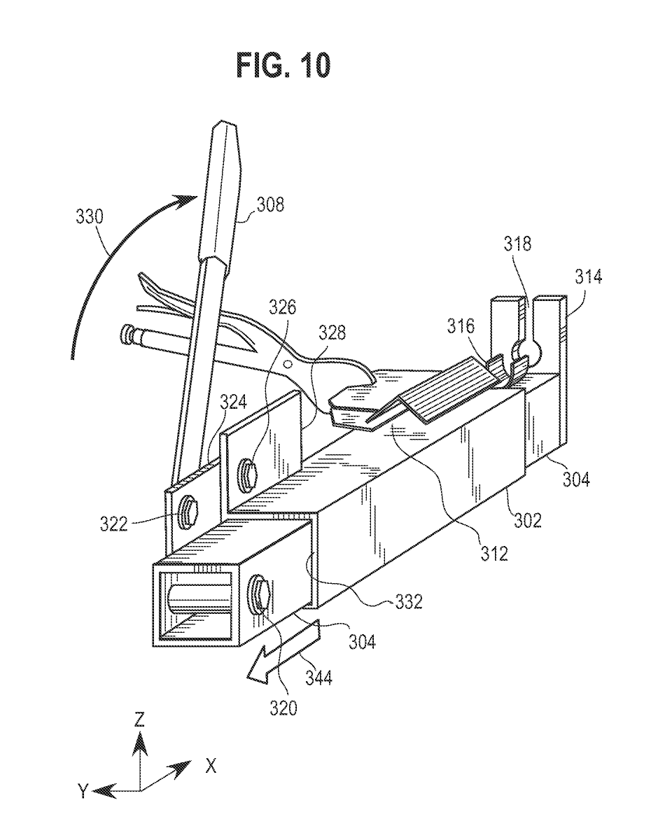

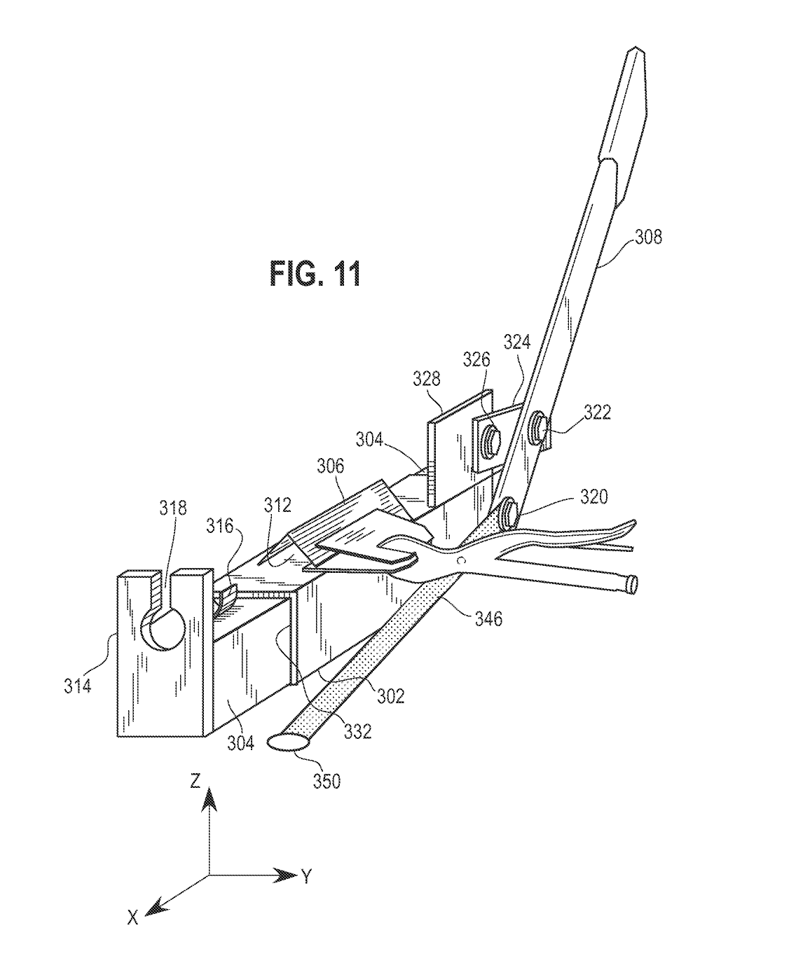

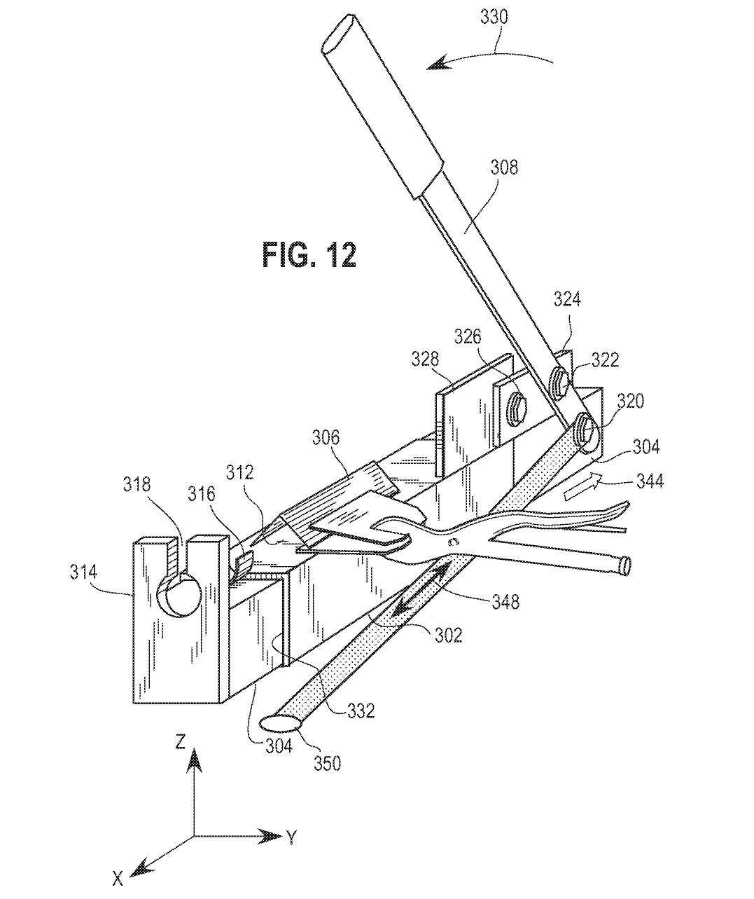

Accordingly, several embodiments provide connection devices and methods of connection for assembling an electrical whip. Throughout this specification, concurrent reference will be made to FIGS. 3-15, which illustrate a connection device in accordance with some embodiments. Additionally, to assist in understanding the relationship between the different views, x-y-z axis indicators are shown in these figures. It is understood that variations from the device illustrated may be made and still be considered within the scope of some embodiments.

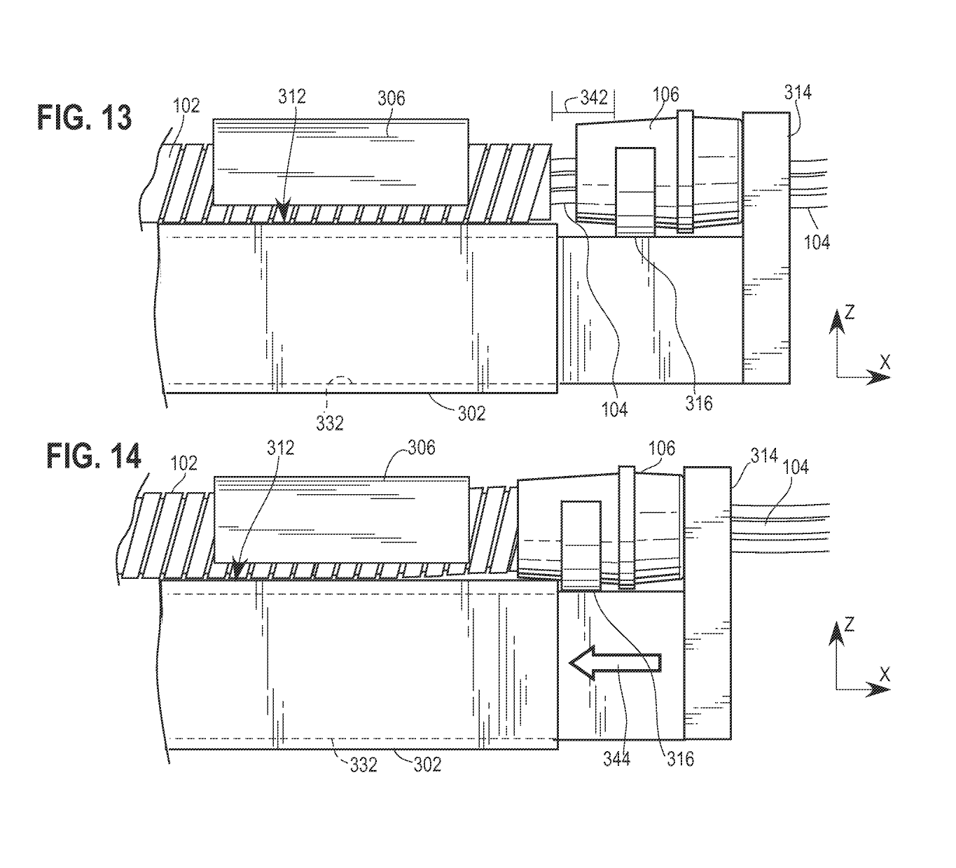

Referring to FIGS. 3-15, a connection device 300 includes a block 302 (which may be generically referred to as a block portion), a piston 304 (which may be generically referred to as a piston portion), a cable retainer 306 (which may be generically referred to as a retaining device), a handle 308, and a hinge assembly 310. In some embodiments, the block 302 has a cable engagement portion 312 (e.g., a fiat surface of the block 302 upon which the flexible cable 102 is retained by the retainer 306). In some embodiments, the piston 304 has an end wall 314 (which may be generically referred to as an end wall portion) and a connector alignment portion 316. The connector alignment portion 316 is shaped to engage and align the connector 106 during use (see FIGS. 13 and 14). The end wall 314 includes an opening or wire channel 318 to allow the wires 104 extending from the cable 102 and connector 106 to extend through the end wall 314 during use (see FIGS. 13 and 14). In some embodiments, the connector alignment portion 316 and the end wall 314 may be integrated together rather than separate components of the piston 304 as illustrated. In some embodiments, the hinge assembly 310 pivotally couples the handle 308 to the block 302 and to the piston 304. In the illustrated embodiments, the hinge assembly 310 includes a first pivot assembly 320 coupled to a first portion of the handle 308 and to a portion of the piston 304; a second pivot assembly 322 coupled to a second portion of the handle 308 and to a pivot component 324; and a third pivot assembly 326 coupled to the pivot component 324 and to a portion 328 of the block 302, wherein the first pivot assembly 320, the second pivot assembly 322 and the third pivot assembly 326 cause the piston 304 to move linearly through the block 302 such that the end wall 314 and the connector alignment portion 316 move linearly toward the block 302 during the manipulation of the handle. For example, the connection device including the block 302 and the piston 304 forms a collapsible slide.

Generally, the connection device 300 has a first position or first orientation in which the cable 102 and connector 106 are positioned to be assembled. This open orientation is illustrated in FIGS. 3. 5, 7, 9, 11 and 13. During use, the handle 308 is manipulated or moved, e.g., by an operator, from the open orientation to a second or closed orientation. For example, the handle 308 is moved in the direction of arrow 330 as shown in FIGS. 2, 4, 6, 8, 10, and 12 such that the connection device 300 is in the closed orientation. During use, the cable 102/cable 112 and connector 106 in unassembled form (see FIGS. 1 and 17) are positioned in the connection device 300 with the connection device 300 in the open orientation such that the cable 102/cable 112 is positioned against the cable engagement portion 312 of the block 302 and retained in position by the retainer 306, and such that the connector 106 is positioned within the connector alignment portion 316 and against the end wall 314, with the wires extending through the wire channel 318 of the end wall 314. This is illustrated in FIG. 13 with cable 102. During use, the connection device 300 is transitioned to the closed orientation which causes the piston 304 to move linearly toward the stationary block 302, and in particular causes the end wail 314 and the connector alignment portion 316 to move linearly toward the block 302 and the cable 102 (or cable 112) as the cable is being retained in position by the retainer 306. The force of the end wall 314 on the connector and the linear movement of the end wall 314 and piston 304 presses the connector 106 over the end of the cable 102 (or cable 112) to create an assembled electrical whip, which once removed from the connection device will be ready for connection or mating to a junction box or other electrical appliance. A detailed view of the assembled electrical whip in the connection device 300 is illustrated in FIG. 14. The transition from the open orientation to the closed orientation is illustrated in FIGS. 13 and 14.

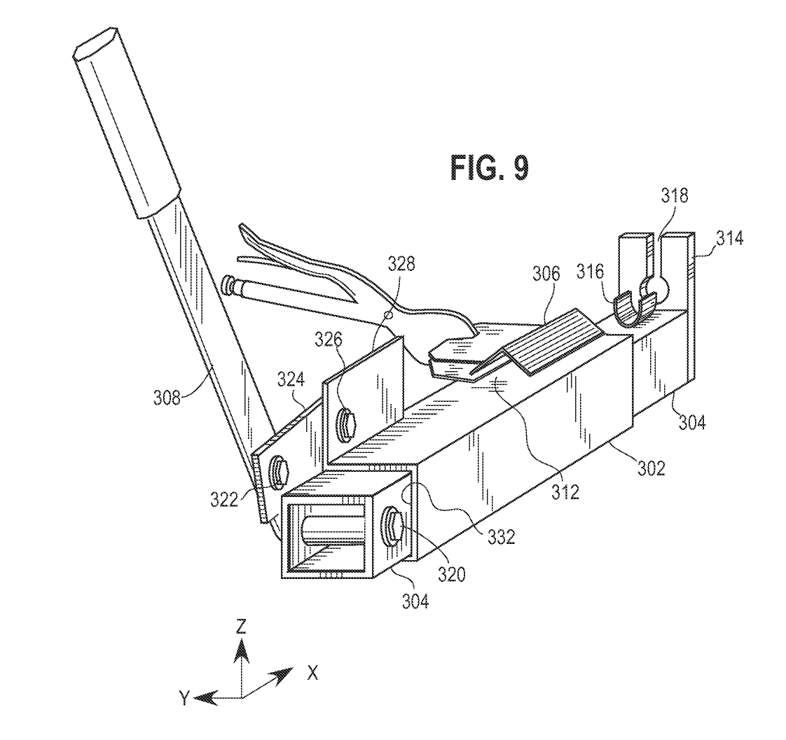

Turning to further details of the connection device 300, reference is made to FIGS. 3-12 which are illustrated without the electrical whip 100 for simplicity and to focus on the structure and function of the components of the connection device of some embodiments. In the open orientation illustrated in FIGS. 3, 5, 7, 9, and 11, the block 302 takes the form of a sold rectangular parallelepiped shaped object having a hollow channel 332 lengthwise extending therethrough (see FIGS. 9-14). For example, the hollow channel 332 allows the piston 304 to extend through the block 302. It is understood that the block and the piston may have several alternate configurations and shapes. When the connection device is transitioned from the open orientation to the closed orientation, the piston 304 is moved linearly horizontally along the x-axis) such that the piston 304 extends further through the hollow channel 332. That is, in some embodiments, the piston 304 moves linearly through at least a portion of the channel 332 as the connection device 300 is moved between the open and the closed orientations.

In the illustrated embodiments, the hinge assembly 310 and the handle 308 allow the piston 304 to move linearly about the x-axis. That is, as the handle 308 is moved in the direction of arrow 330, the piston is moved through a portion of the channel 332. This causes the end wall 314 and the connector alignment portion 316 to move toward (when transitioning to the closed orientation) and away from (when transitioning to the open orientation) the block 302. With the first pivot assembly 320, the handle is pivotally and rotatably coupled to one end of the piston 304 that extends through a back side (side opposite the end wall 314) of the block 302. With the second pivot assembly 322, the handle 308 is also pivotally and rotatably coupled to one portion (e.g., end) of the pivot component 324 which takes the form of a plate. With the third pivot assembly 326, another portion (e.g., other end) of the pivot component 324 is pivotally and rotatably coupled to the block portion 328 fixed to the block 302. All of the first, second and third pivot assemblies provide a rigid connection between components but allow rotation between the various connected components. When the handle 308 is in the open orientation (see FIGS. 3, 5, 7, 9, and 11), the piston extends completely through the channel 332 but at a location where there is a gap 342 between the connector engagement portion 316 and the block 302. When the handle 308 is moved in the direction of arrow 330, the pressure and force from the handle 308 and the hinge assembly 310 cause the piston 304 to move linearly through block 302 in the direction of arrow 344 (e.g., left on the x-axis in FIGS. 4 and 8). As can be seen, the first pivot assembly 320 moves in the direction of arrow 344. Also, the end wall 314 and the connector alignment portion 316 move in the direction of arrow 344. In the illustrated embodiments, this movement reduces the gap 342 between the connector alignment portion 316 and the block 302. When the connector 106 is in position, the end wall 314 moves in the direction of arrow 344 and engages the connector 106 and presses the connector 106 over the end of the cable 102 (or cable 112) such as illustrated in FIG. 14. In the illustrated embodiments, the connector 106 is a compression or snap fit type fitting, such as the 38AST snapfit connector commercially available from Arlington Industries, Inc. of Scranton, Pa. Once pressed over the cable 102 or cable 112, the connector 106 includes a feature on the inner diameter to engage and retain the connector 106 in position on the cable 102.

In some embodiments, the connector alignment portion 316 takes the form of a U-shaped member having two opposing sides extending upward in the shape of a letter U. The U-shaped member has an inner curvature substantially corresponding to an outer diameter of the connector 106. The U-shape allows the connector 106 to be easily positioned therein (e.g., see FIG. 14) and does not limit linear movement of the connector 106 along the x-axis. However, in some embodiments, the width of the U-shaped portion along the x-axis limits potential misalignment of the connector 106 along the x-axis as it is pressed on to the cable 102, i.e., movement of the connector 106 along the y-axis is limited by the U-shaped member.

In some embodiments, the end wall 314 includes the wire channel 318 to allow the electrical wires extending from the connector 106 to continue extending therethrough so as not to interfere with the compression fit of the connector to the cable by the end wall 314. In some embodiments, the wire channel 318 includes a narrow slot to allow insertion of the wires 104 and widens to an opening having to accommodate all wires together.

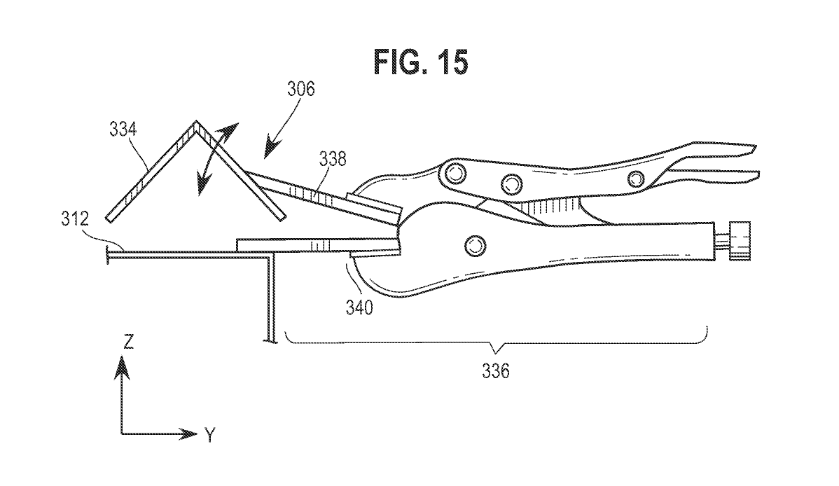

In some embodiments, as is best seen in FIG. 15, the retainer 306 takes the form of clamping grip 336 coupled to a triangular roof-like structure or hood 334 that is clamped in position over the cable 102 in order to releasably retain the cable 102 against the cable engagement portion 312. The clamping grip 336 (e.g., a sheet metal vice grip having two grip arms, each with a flat plate welded thereto) is coupled to the hood 334 and to the block 302, e.g., a first grip arm 338 is attached (e.g., welded) to the hood 334 (e.g., the hood 334 is welded to a top edge of the flat plate of the first grip arm 338) and a second grip arm 340 is attached (e.g., welded) to the block 302 (e.g., an edge of the flat plate of the second grip arm 340 is welded to the block 302). In operation, the cable 102 (or cable 112) is placed against the cable engagement portion 312 under the hood 334 and the clamping grip is used to releasably retain the cable against the block. It is understood that the hood 334 may have many suitable forms to retain the cable in position, e.g., the, hood may have a curvature substantially matching a curvature of the cable, may be flat, rectangular, etc. In some embodiments, the clamping grip may be locked into the clamped position, e.g., using a lock screw common to vice grips. It is further noted that the retainer 306 may take other forms, such a spring biased member that uses the force of a spring on a component (such as a hood) to retain the cable. Manual pressure against the spring will open the component, to allow insertion and removal of the cable from the retainer.

It is understood that the cable 102 may be jacketed (see cable 112 in FIGS. 17 and 18) or non-jacketed (see cable 102 in FIGS. 1 and 2). For example, a jacketed MC cable is a metal clad cable with a protective outing coating, e.g., made of PVC or similar material. Jacketed cables are more water proof than non-jacketed cables. In either case, the cable remains substantially rigid but still flexible. In use, jacketed cables tend to require more user force or pressure to apply the connector 106 to the cable 112 compared to that needed with cable 102 due to the increased diameter of the cable 112 relative to the cable 102 given the same connector 106.

In some embodiments, one or more of the components of the connection device 300 are made of a metal or metallic material to enhance the strength of the connection device. For example, one or more of the block 302, the retainer 306, the piston 304, the connector alignment portion 316, the end wall 314, the handle 308, and the hinge assembly 310 comprise a metal or metallic material.

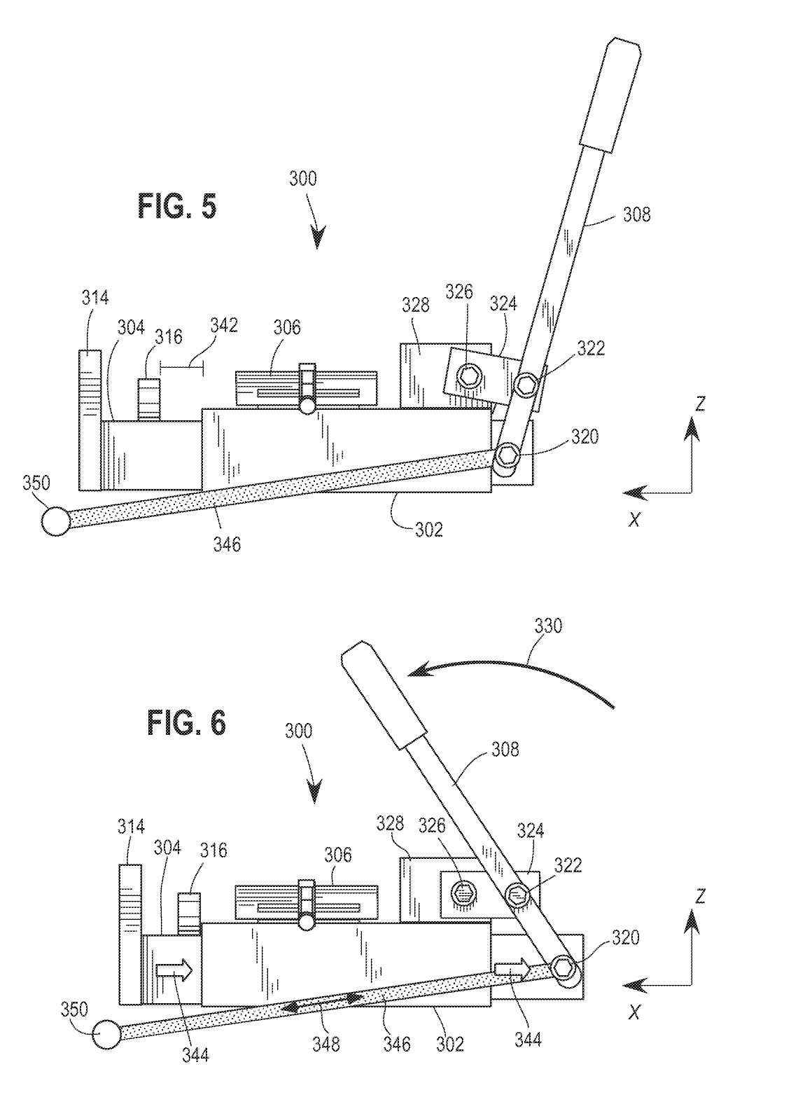

In some embodiments, a handle return 346 (generically referred to as a handle return device) is coupled to a portion of the handle 308 and is configured to introduce a resistance force on the handle 308 during the manipulation of the handle when the connection device is transitioned to the closed orientation. Some embodiments of the handle return 346 are illustrated in FIGS. 5, 6, 11, and 12. In some embodiments, the handle return 346 comprises an elastic member that is coupled to the handle 308 and anchored to a fixed surface 350 (such as a work surface, table, bench, etc.) and is stretched in the directions of arrow 348 when the handle is moved in the direction of arrow 330. Thus, when the user ceases movement or manipulation of the handle, the resistance force from the stretching causes the handle to return to an original position in the open orientation. In this way, the operator need only remove the operator's hand from the handle 308 and the handle will automatically return to its original orientation. This improves the speed and efficiency of the operator when assembling multiple electrical whips. It is understood that the handle return may have other configurations. For example, in some embodiments, the handle return includes a spring or spring mechanism coupled to the handle 308 and secured to a fixed location to introduce the resistance force.

Generally, the connection device of several embodiments provides for easier assembly of electrical whips without the use of manual force and holding pieces by hand which has proven time consuming and difficult, in particular with jacketed cables. Embodiments of the connection device allow the connector to be fit to the cable with little manual force due to the leverage created by the handle and the block/piston allow for quick installation, while securing the components being fit together. For example, in some embodiments, an operator may apply as little as about 10-15 pounds of force to the handle 308, and in some embodiments, the operator may apply as little as about 12-13 pounds of force to the handle 308 in order to press the connector onto a jacketed cable 112. Again doing so by hand without a connection device such as described herein is very difficult in that a user must hold both components by hand or press on component against the other and apply significantly more force than when using a connection device such as described herein. For example, due to the mechanical structure of the connection device including the handle, hinge mechanism, block and piston, less operator force on the handle is translated into a greater force by the end wall on the connector. In some cases, due to the manual force needed without a connection device, the operator rests the connector against a stationary Object and uses both hands to force the cable onto the connector, but if the connector is not held securely or the cable not pressed evenly, the cable may not align well with the connector. It may take 30 seconds to one minute or longer to assemble one electrical whip and it may be difficult to properly align the connector onto the cable. In some embodiments of the connection device, an electrical whip can be assembled in less than 10 seconds, and in some cases, less than 5 seconds. Further, electrical whips may be assembled with less force applied by the operator, resulting in less fatigue to the operator and less risk of injury. Additionally, electrical whips may be assembled with better alignment due to the guided linear movement of the piston and secure placement of components, relative to manual assembly techniques. Thus, in some embodiments, the process of assembling an electrical whip is more efficient, faster and requires less operator force application. In manufacturing processes where tens or hundreds of electrical whips are assembled by a single operator in a day, the connection device greatly improves assembly output and connection quality and reliability.

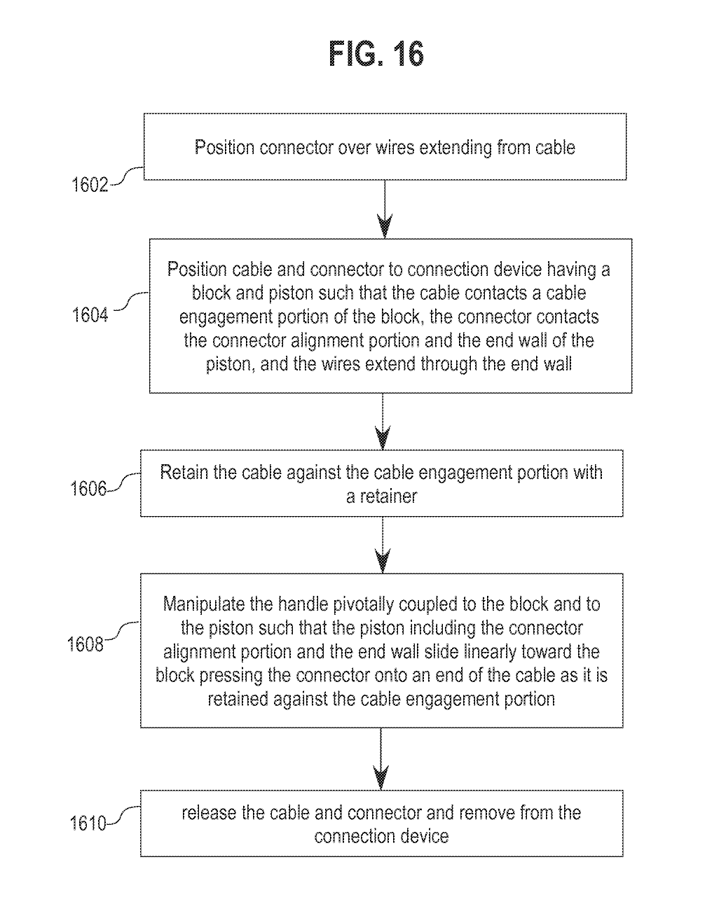

Reference is now made to the flow diagram of FIG. 16 which illustrates a process of assembling an electrical whip using a connection device such as described herein. Initially, a connector is positioned over wires extending from a metal clad cable (Step 1602). For example, the connector 106 is positioned over the wires 104 relative to the cable such as shown in FIG. 1 or FIG. 17. The connector and cable may be any such devices described herein or other alternatives.

Next, the cable and connector are positioned to a connection device (e.g., connection device 300) having a block (e.g., block 302) and a piston (e.g., piston 304) such that the cable contacts or engages a cable engagement portion (e.g., cable engagement portion 312) of the block, the connector contacts the connector alignment portion (e.g., connector alignment portion 316) and the end wall (e.g., end wall 314) of the piston, and such that the wires extend through the end wall (Step 1604). The block is fixed in position and the piston is linearly moveable toward and away from the block portion. In some embodiments, the piston extends through a hollow channel formed in the block such that the end wall and the connector alignment portion move toward and away from the block with movement of the piston. Next, the cable is retained against the cable engagement portion with a retainer (e.g., retainer 306) (Step 1606). This fixes the position of the cable during use of the connection device. FIG. 13 illustrates some embodiments of the resulting configuration after performing steps 1604 and 1606.

Next, a handle (e.g., handle 308) pivotally coupled to the block and to the piston (e.g. via hinge assembly 310) is manipulated (e.g., moved in the direction of arrow 330) such that the piston including the connector alignment portion and the end wall slide linearly toward the block pressing the connector onto an end of the cable as it is retained against the cable engagement portion (Step 1608). FIG. 14 illustrates some embodiments of the resulting configuration after performing step 1608.

And then the cable with attached connector is released from the retainer and removed from the connection device (Step 1610). Some embodiments of the assembled electrical whip 100 are shown in FIG. 2 and FIG. 18. The assembled electrical whip is now ready for use, e.g., to be coupled to an electrical junction box, panel, enclosure, etc.

It is understood that this method may differ according to any of the variations described herein with respect to FIGS. 1-15. Additionally, in some embodiments, the connection device includes a handle return (e.g., handle return 346) such that upon cessation of the manipulating step, the handle return causes the handle to return to its original position or open orientation. In some embodiments, the handle return introduces a resistance force on the handle during the manipulating step. In some embodiments, the handle return is an elastic member that stretches during the manipulating step to provide the resistance force. In some embodiments, the handle return includes a spring or spring mechanism coupled to the handle 308 and secured to a fixed location that expands during the manipulating step to provide the resistance force.

In some embodiments, apparatuses and methods are provided herein useful to assemble an electrical whip. In some embodiments, a connection device for use in assembling an electrical whip comprising: a block portion fixed in position and having a cable engagement portion configured to engage an end portion of a metal clad cable having electrical wiring extending therefrom; a retaining device coupled to the block portion and configured to releasably retain the end portion of the metal clad cable against the cable engagement portion; a piston portion having a connector alignment portion and an end wall portion, wherein the connector alignment portion is configured to receive a connector with the electrical wiring extending therethrough, and wherein the end wall portion is configured to contact the connector while allowing the electrical wiring to extend therethrough; a handle; and a hinge assembly pivotally coupling the handle to the block portion and to the piston portion, wherein upon a manipulation of the handle, the piston portion including the connector alignment portion and the end wall portion slide linearly toward the block portion pressing the connector onto the end of the metal clad cable as it is retained against the cable engagement portion by the retaining device.

In some embodiments, a method of assembling an electrical whip, comprises: positioning a metal clad cable having electrical wiring extending therefrom through a connector to be pressed onto an end of the metal clad cable against a cable engagement portion of a block portion of a connection device such that a portion of the metal clad cable engages the cable engagement portion, such that the connector is received in a connector alignment portion of a piston portion of the connection device and such that the electrical wiring extends through an end wall portion of the piston portion, wherein the block portion is fixed in position and the piston portion is linearly moveable toward and away from the block portion; retaining the metal clad cable against the cable engagement portion with a retaining device coupled to the block portion; manipulating a handle pivotally coupled to the block portion and to the piston portion via a hinge assembly such that the piston portion including the connector alignment portion and the end wall portion slide linearly toward the block portion pressing the connector onto the end of the metal clad cable as it is retained against the cable engagement portion by the retaining device; and releasing the metal clad cable having the connector pressed thereon from the retaining device and removing the metal clad cable and connector from the connection device

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A connection device for use assembling an electrical whip, the device comprising:
a block portion fixed in position and having a cable engagement portion configured to engage an end portion of a metal clad cable having electrical wiring extending therefrom;
a retaining device coupled to the block portion and configured to releasably retain the end portion of the metal clad cable against the cable engagement portion;
a piston portion having a connector alignment portion and an end wall portion, wherein the connector alignment portion is configured to receive a connector with the electrical wiring extending therethrough, and wherein the end wall portion is configured to contact the connector while allowing the electrical wiring to extend therethrough;
a handle; and
a hinge assembly pivotally coupling the handle to the block portion and to the piston portion,
wherein upon a manipulation of the handle, the piston portion including the connector alignment portion and the end wail portion slide linearly toward the block portion pressing the connector onto the end of the metal clad cable as it is retained against the cable engagement portion by the retaining device.

2. The connection device of claim 1, wherein the connector alignment portion comprises a U-shaped portion configured to extend about two opposing sides of the connector and ensure that the connector moves linearly toward the block portion during the manipulation.

3. The connection device of claim 1, wherein the end wall portion includes a wire channel configured to allow the electrical wires to be positioned therein and extend therethrough.

4. The connection device of claim 1, wherein the block portion comprises a hollow channel extending linearly therethrough, wherein the piston portion extends through the hollow channel, and wherein during the manipulation, the piston portion extends further through the hollow channel.

5. The connection device of claim I, wherein the hinge assembly comprises:
a first pivot assembly coupled to a first portion of the handle and to a portion of the piston portion;
a second pivot assembly coupled to a second portion of the handle and to a pivot component;
a third pivot assembly coupled to the pivot component and to a portion of the block portion;
wherein the first pivot assembly, the second pivot assembly and the third pivot assembly cause the piston portion including the end wall portion to move linearly toward and away from the block portion during the manipulation of the handle.

6. The connection device of claim 1, wherein the metal clad cable comprises a jacketed metal clad cable.

7. The connection device of claim 1, wherein the connector comprises a metal connector adapted to mate to an electrical junction box.

8. The connection device of claim 1, further comprising a handle return device coupled to a portion of the handle, and configured to introduce a resistance force on the handle during the manipulation of the handle, wherein upon cessation of the manipulation, the resistance force causes the handle to return to an original position.

9. The connection device of claim 8 wherein the handle return device comprises an elastic member coupled to a portion of the handle and anchored to a surface.

10. The connection device of claim 1 wherein the block portion, the retaining device, the piston portion, the connector alignment portion, the end wall portion, the handle, and the hinge assembly all comprise metal components.

11. A method of assembling an electrical whip, comprising:
positioning a metal clad cable having electrical wiring extending therefrom through a connector to be pressed onto an end of the metal clad cable against a cable engagement portion of a block portion of a connection device such that a portion of the metal clad cable engages the cable engagement portion, such that the connector is received in a connector alignment portion of a piston portion of the connection device and such that the electrical wiring extends through an end wall portion of the piston portion, wherein the block portion is fixed in position and the piston portion is linearly moveable toward and away from the block portion;
retaining the metal clad cable against the cable engagement portion with a retaining device coupled to the block portion;
manipulating a handle pivotally coupled to the block portion and to the piston portion via a hinge assembly such that the piston portion including the connector alignment portion and the end wall portion slide linearly toward the block portion pressing the connector onto the end of the metal clad cable as it is retained against the cable engagement portion by the retaining device; and
releasing the metal clad cable having the connector pressed thereon from the retaining device and removing the metal clad cable and connector from the connection device.

12. The method of claim 11, wherein the connector alignment portion comprises a U-shaped portion configured to extend about two opposing sides of the connector such that during the manipulating step, the connector moves linearly toward the block portion.

13. The method of claim 11, wherein the end wall portion includes a wire channel configured to allow the electrical wires to be positioned therein and extend therethrough during the positioning step, the retaining step and the manipulating step.

14. The method of claim 11, wherein the block portion comprises a hollow channel extending linearly therethrough, wherein the piston portion extends through the hollow channel, and during the manipulating step, the piston portion extends further through the hollow channel.

15. The method of claim 11, wherein the hinge assembly comprises:
a first pivot assembly coupled to a first portion of the handle and to a portion of the piston portion;
a second pivot assembly coupled to a second portion of the handle and to a pivot component;
a third pivot assembly coupled to the pivot component and to a portion of the block portion;
wherein during the manipulating step, the first pivot assembly, the second pivot assembly and the third pivot assembly cause the piston portion including the end wall portion to move linearly toward and away from the block portion.

16. The method of claim 11, wherein the metal clad cable comprises a jacketed metal clad cable.

17. The method of claim 11, wherein the connector comprises a metal connector adapted to mate to an electrical junction box.

18. The method of claim 11, further comprising causing, upon cessation of the manipulating step, the handle to return to an original position through use of a handle return device coupled to a portion of the handle and configured to introduce a resistance force on the handle during the manipulating step.

19. The method of claim 18 wherein the handle return device comprises an elastic member coupled to a portion of the handle and anchored to a surface, wherein the elastic member stretches during the manipulating step to provide the resistance force.

20. The method of claim 11 wherein the block portion, the retaining device, the piston portion, the connector alignment portion, the end wall portion, the handle, and the hinge assembly all comprise metal components.
